(19) United States
(12) Patent Application Publication
(10) Pub. No.: US 2003/0136608 A1
(43) Pub. Date: Jul. 24, 2003

(54) Escape system

(76) Inventor: Ray Gunthardt, Tempe, AZ (US)

Correspondence Address: Ray Gunthardt, 1915 E. Loyola Dr., Tempe, AZ, 85282, US

(21) Appl. No.: 10/349,355

(22) Filed: Jan. 21, 2003

Related U.S. Application Data
(60) Provisional application No. 60/351,025, filed on Jan. 23, 2002.

(51) Int. Cl. A62B 1/20

(52) U.S. Cl. 182/48

(57) ABSTRACT

The Escape System provides fast and safe escape from architecture for larger numbers of people. The system can even evacuate an entire skyscraper in just a few minutes, while age, disabilities, injuries or even unconsciousness of evacuees do not impair the efficiency ot the evacuation (they only need an assistant). Even CPR could be administered during an evacuation. The banking and geometry of the slide surface utilizes the laws of physics to separate the faster sliders from the slower ones. The maximal number of people evacuated can exceed 200 per second, or 12,000 per minute per system. Optional Escape devices, such as Escape-Tunnels, can be used alone, or enhance the functionality of the system and offer choices of escape routes to the evacuees. Either configuration can be installed in new architecture, or retrofit existing ones.

### CROSS-REFERENCE TO RELATED APPLICATIONS

This application is related to prior Application No. 60/351,025 filed on: Jan. 23, 2002, former title: “Emergency Mass Evacuation System”

### FIELD OF THE INVENTION

This invention relates to escape systems for architectures.

### BACKGROUND OF THE INVENTION

The devastating loss of life of Sep. 11, 2001 has tragically proven the complete inexistence of any evacuation systems or devices capable of evacuating even a smaller number of people. Traditional traffic routes, such as elevators and stairways, are insufficient or can even become very dangerous under certain conditions, like power failures. The intense traffic density of the stairways instantly forces the pace to a crawl, with potentially horrific consequences. Personal safety devices such as parachutes, bungee-cords and others have severe limitations, or can not be used at all, since for example windows in skyscrapers are shatter-proof.

In an effort to maximize the chances of survival while minimizing injuries, inventor spent considerable time and efforts toward finding the most advanced and optimal escape systems, methods and devices. Age, disabilities, injuries or even unconsciousness must not impair fast and safe evacuation, during which CPR should be possible.

Thus, there is a need for reliable and advanced escape systems that allow fast evacuation of a vast number of people in a very short time frame, and with minimal potential for injuries.

### BRIEF SUMMARY OF THE INVENTION

The basic concept of the invention is to evacuate everyone in a building as fast and safely as possible. This especially applies to large structures occupied by tens of thousands of people. The escape system is not limited to an exclusively internal or external system, it can employ any combination. Even already existing skyscrapers for example could be upgraded with a mainly exterior escape system as described below.

The fundamental concept of the escape system is to move people away from a dangerous area or section of an architecture to a secure location, or total evacuation if required, in a fast and safe fashion. In the first example illustrated, people enter a gigantic water-slide, exit the slide into a specially designed pool, then are transferred by one of several conveyor belts to finally step on ground level a safe distance away from the building. The water-slide itself has no moving parts that could fail, and is powered by gravity.

As a second example. escape-tunnels enable people to transfer from one architecture to another, or to the ground, or to a safe zone.

Alternatively, a wide variety of devices and/or systems in any combination can be used. Mechanical, electromagnetic and hydraulic components are just a few potential candidates. For instance, large pockets or cells, connected to belts or other flexible carriers, can transport people to ground level. Escape cells conveying in electromagnetic fields can accomplish the dame task.

Further, even an entire section or several sections of a floor can move out of a skyscraper, remain there until for example a fire in an adjacent section is extinct, then move back in. If this should take too long, or the situation is too dangerous, the entire section or sections can be lowered to the ground level in a very fast but safe fashion.

The invention could be abbreviated as: “Out and safe, or out-back in when safe”. Consistent with the foregoing, the invention also contemplates associated methods, systems and concepts.

### BRIEF DESCRIPTION OF THE DRAWINGS

Referring to the drawings:

FIG. 1 is a perspective view of the escape system, in accordance with the invention.

FIG. 2 is perspective view of the venturi-pool, in accordance with the invention.

### DETAILED DESCRIPTION OF THE INVENTION

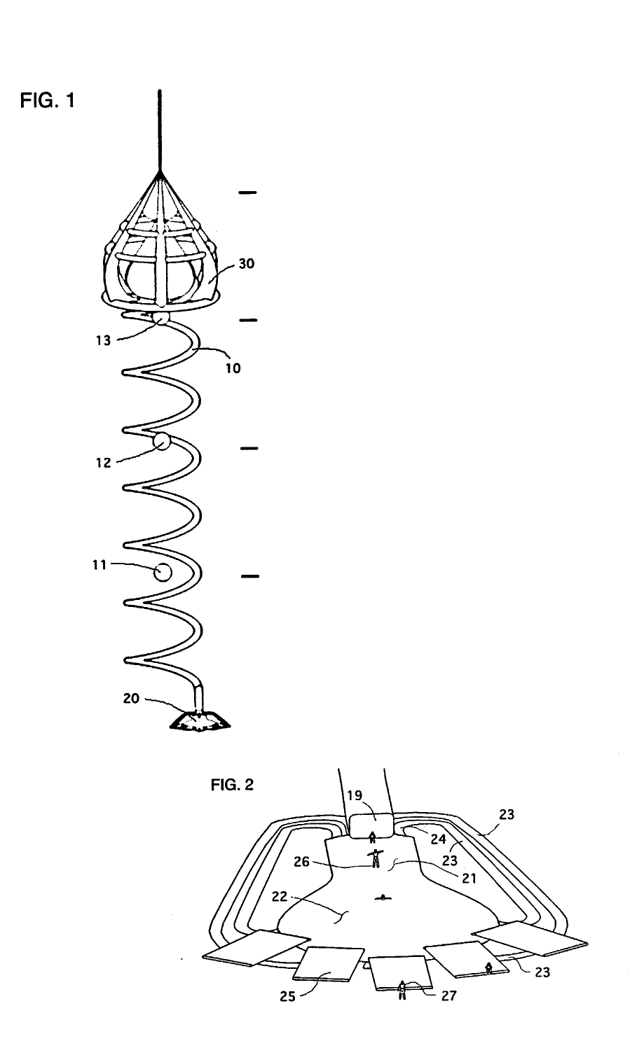

Turning now to the figures, FIG. 1 is a perspective view of the escape system illustrated on a 80 story skyscraper with an estimated occupancy of 250 people per story, a total of 20,000.

The water-slide 10 spiraling down from the tip of the top-section 30 to almost the ground level, where the evacuees enter the venturi-pool 20. The water is pumped from the venturi-pool into the largest water-tank 11 on floor 21. This tank also fills the water-tank 12 on floor 41. The water-tank 13 on floor 61 and the water-tank on floor 81 are supplied correspondingly. Each of these tanks deliver water by gravity to the 20-story section of the water-slide just below a particular tank for 10 minutes, even in case of total power failure. The following numerical example is used to illustrate the functionality of the invention: Slide-Helix: mean radius 20 m (66 ft), a slope of 15 degrees. Constant slide-speed of 32 miles per hour (52 km/h), about as fast as water-skiing. Vertical drop speed: 1 story per second, 80 s total. Friction: a person's weight, clothing (cotton, synthetics, silk, skin, shoes) and other variables influence the velocity. One access slide per story into the slide 10 allows each person to accelerate to the average speed in the main spiral 10, to gradually “merge with the traffic”, similar to a highway on-ramp. Entry intervals: 2 persons per second per story per main slide 10. Access: stories 5 to 80, 76 floors. Slide Width: start: 4 m (12 ft), end: 10 m (33 ft) (8 people wide). Sliding position: sitting with the feet on the slide and the elbows resting on the knees to avoid injury if people would bump into each other. Shoes and high-heels should not be worn to avoid significant differences of friction coefficients and resulting different sliding speeds, broken ankles and other injuries. The banking and geometry of the slide surface: the laws of physics separate the faster sliders traveling on the outer radius from the slower ones on the inner radius. Total evacuation time: entry: 125 s [250/(2/s)]+slide: 80 s=205 s=3 min. 25 s for 19,000.

At the same instant, one person per story enters the system, a total of 76 (floors 5 to 80). This action occurs twice every second, theoretically for 125 sec. until suddenly all stories are empty. After 80 seconds the slide has reached maximum capacity. Examining one-second-segments of the slide: the 5 sec old segment (at floor 76) holds 10 people, the 76 sec old segment (floor 5) holds 152 people. There is no access at story 4 or below. The total of all persons in all these segments add to 2*2926+4*152=6460. The maximal number of people exiting the slide is 152 per second, or 9120 per minute, over 200/s is achievable. The length of a 1-second-segment is 14.44 meters or 47.4 ft. Potentially 20 rows of people, 9 people wide, would easily fit into each segment.

Disabled, injured or unconscious people: a helper sits behind that person, extends the arms forward under the victims shoulders, and crosses the arms over the victims abdomen. This is a safe and stable sliding configuration to enter the access slide.

CPR: In this sitting position, the paramedic folds one hand over the fist of the other hand, positioned over the victims chest. This enables rapid compression of the chest. An air-pump bottle with mask is intermittently used to breath the victim.

FIG. 2 is perspective view of the venturi-pool. The sliders leave the slide-exit 19 of the water-slide slightly above the high-velocity-section 21 of the venturi-pool and dip in. The water flow is slightly faster than the horizontal speed of the sliders, to avoid a dangerous pile-up. Soon afterwards the pool widens to over three times the width and depth of the low-speed-section 22. This reduces the speed to less than 1/9. Regardless if the sliders are just wet, injured or unconscious, the water flow transports the people right onto one of several conveyor belts 25. The conveyor belts begin below the pool surface to pick up people who may end up at at the very bottom of the pool. The conveyors pull the evacuees 27 out of the water and move them a further away. While sitting on the conveyors 25, traveling at walking speed, the evacuees 27 move their feet to face forward. At the end of the conveyor belts 25, the evacuees 27 are set down on the grass, automatically walking at the speed of the conveyor belts 25, avoiding a slow down. The grass area is gently sloped away from the pool. Even disoriented people will follow the slope downwards, automatically clearing the end of the conveyor belts. Paramedics main focus concentrates on those who remain near the belts 25. The conveyors dangerous areas are blocked by strong metal screens that allow water to flow through, but guide the people in the desired direction.

The water flow can easily be achieved by four well proven marine propulsion systems, as used in larger motorboats. These propulsion systems are installed indoors on the first floor, under the slide-exit 19. The two large water pipes 23 on each side of the pool supply the propellers or jet drives with the water to generate the required flow rate in the venturi.

Thus, Escape Systems are disclosed that enable efficient and safe evacuation of even an enormous number of people in an extremely fast fashion, regardless of the condition of the evacuees. While I have shown and described a specific description of the present invention, further modifications and improvements will occur to those skilled in the art. I desire it to be understood, therefore, that this invention is not limited to the particular forms shown or described, and I intend in the appended claims to cover all modifications that do not depart from the spirit and scope of the invention.

What I claim is:

1. An escape system for architectures.

2. The escape system of claim 1, wherein the components are mainly located inside the architectures.

3. The escape system of claim 1, wherein the components are mainly outside the architectures.

4. The escape system of claim 1, wherein the components are located inside and outside the architectures.

5. The escape system of claim 1, wherein safe evacuation for even massive numbers of people is possible, even in an extremely short time frame.

6. The escape system of claim 1, wherein gravitational, mechanical, magnetic, electromagnetic, hydraulic, aerodynamic or any other systems of devices may be utilized.

7. The escape system of claim 1, wherein the function is not affected by total power failure.

8. The escape system of claim 1, wherein the banking and geometry of the slide surface utilizes the laws of physics to separate the faster sliders from the slower ones.

9. The escape system of claim 1, wherein age, disabilities, injuries or even unconsciousness of evacuees does not impair the efficiency ot the evacuation.

10. The escape system of claim 1, wherein CPR is feasible during the evacuation.

11. An optional escape device of an escape system for architectures, such as escape-tunnels.

12. The optional escape device of claim 11, wherein the device interacts with another escape system for architectures.

13. The optional escape device of claim 11, wherein the device does not interacts with another escape system for architectures.

14. The optional escape device of claim 11, wherein the device enables the escape to adjacent architectures, ground or safe area.

15. The optional escape device of claim 11, wherein the device can be moved, lowered, extended, tilted or otherwise controlled.

16. The optional escape device of claim 11, wherein the device can employ guiding devices for optimal function or maneuverability.

17. The optional escape device of claim 11, wherein the device can employ devices to automatically open windows or otherwise clear the escape passage.

18. The optional escape device of claim 11, wherein the device can be made of strong screen metal or be otherwise well ventilated, to avoid fire, smoke or other hazards to pass through.
